(19) United States
(12) Patent Application Publication
(10) Pub. No.: US 2016/0311072 A1
(43) Pub. Date: Oct. 27, 2016

(54) METHOD OF MANUFACTURING AXIAL FAN WHEEL

(71) Applicant: COOLER MASTER CO., LTD., New Taipei City (TW)

(72) Inventors: Chen-Yang Lin, New Taipei City (TW); Jia-Lang Hsu, New Taipei City (TW)

(21) Appl. No.: 14/692,750

(22) Filed: Apr. 22, 2015

(51) Int. Cl. B23P 15/00

(52) U.S. Cl. CPC B23P 15/006

(57) ABSTRACT

A method of manufacturing an axial fan wheel includes steps of providing a raw material; forging the raw material by a forging process to form a semifinished product of the axial fan wheel, wherein the semifinished product of the axial fan wheel includes a hub, a plurality of axial fan blades and an excess material, the axial fan blades extend from a periphery of the hub, an angle included between a surface of each axial fan blade and a rotation axis of the hub varies gradiently, and the excess material is connected to the hub and the axial fan blades; and removing the excess material to form the axial fan wheel with the hub and the axial fan blades.

### BACKGROUND OF THE INVENTION

1. Field of the Invention

The invention relates to a method of manufacturing an axial fan wheel and, more particularly, to a method of manufacturing an axial fan wheel by a forging process.

2. Description of the Prior Art

Heat dissipating device is a significant component for electronic products. When an electronic product is operating, the current in circuit will generate unnecessary heat due to impedance. If the heat is accumulated in the electronic components of the electronic product without dissipating immediately, the electronic components may get damage due to the accumulated heat. Therefore, the performance of heat dissipating device is a significant issue for the electronic product. So far the heat dissipating device used in the electronic product usually consists of a heat pipe, a heat dissipating fin and a fan, wherein a heat absorbing segment of the heat pipe contacts the electronic component, which generates heat during operation, a heat dissipating segment of the heat pipe is connected to the heat dissipating fin, and the fan blows air to the heat dissipating fin, so as to dissipate heat. Accordingly, the fan is a significant component of the electronic device. When manufacturing a fan wheel of the fan, the prior art always manufactures a plurality of fan blades and a hub individually and then assembles the fan blades and the hub. Therefore, the prior art needs longer time to manufacture the fan and a connection error may occur during the process of assembling the fan blades and the hub.

### SUMMARY OF THE INVENTION

The invention provides a method of manufacturing an axial fan wheel by a forging process, so as to solve the aforesaid problems.

According to an embodiment of the invention, a method of manufacturing an axial fan wheel comprises steps of providing a raw material; forging the raw material by a forging process to form a semifinished product of the axial fan wheel, wherein the semifinished product of the axial fan wheel comprises a hub, a plurality of axial fan blades and an excess material, the axial fan blades extend from a periphery of the hub, an angle included between a surface of each axial fan blade and a rotation axis of the hub varies gradiently, and the excess material is connected to the hub and the axial fan blades; and removing the excess material to form the axial fan wheel with the hub and the axial fan blades.

As mentioned in the above, the invention forms the semifinished product of the axial fan wheel by the forging process first and then removes the excess material from the semifinished product of the axial fan wheel, so as to obtain the axial fan wheel with the hub and the axial fan blades integrally. Since the invention needs not to assemble the axial fan blades and the hub, the manufacturing time can be reduced effectively and a connection error will not occur between the axial fan blades and the hub.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method of manufacturing an axial fan wheel according to an embodiment of the invention.

FIG. 2 is a schematic view illustrating the process associated with the method shown in FIG. 1.

FIG. 3 is a schematic view illustrating another process associated with the method shown in FIG. 1.

### DETAILED DESCRIPTION

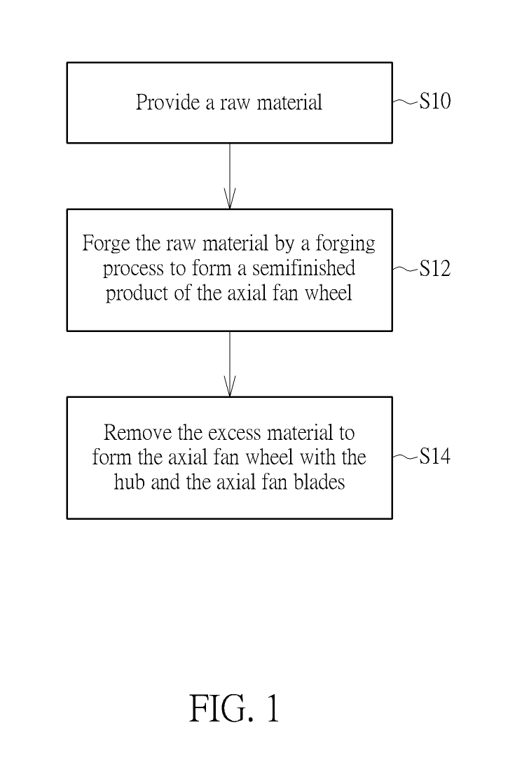

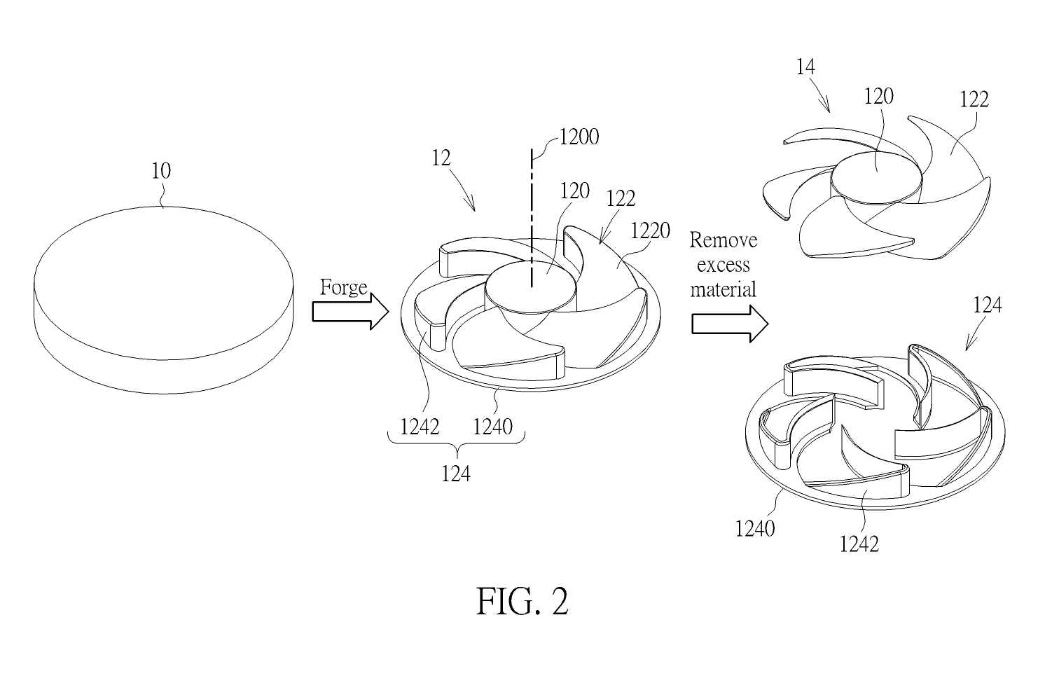

Referring to FIGS. 1 and 2, FIG. 1 is a flowchart illustrating a method of manufacturing an axial fan wheel according to an embodiment of the invention, and FIG. 2 is a schematic view illustrating the process associated with the method shown in FIG. 1. First of all, step S10 is performed to provide a raw material 10. In this embodiment, the raw material 10 may be Mg, Al, Fe, Ti, magnesium alloy, aluminum alloy, ferro-alloy, titanium alloy, or other metals or alloys capable of being used in a forging process. Afterward, step S12 is performed to forge the raw material 10 by a forging process to forma semifinished product 12 of the axial fan wheel, wherein the semifinished product 12 of the axial fan wheel comprises a hub 120, a plurality of axial fan blades 122 and an excess material 124. As shown in FIG. 2, the axial fan blades 122 extend from a periphery of the hub 120. Since a surface 1220 of each axial fan blade 120 renders a specific curve in a specific curvature, an angle included between the surface 1220 of each axial fan blade 120 and a rotation axis 1200 of the hub 120 varies gradiently.

After forming the semifinished product 12 of the axial fan wheel by the forging process, the excess material 124 is connected to the hub 120 and the axial fan blades 122. In this embodiment, the excess material 124 may comprise a base 1240 and a plurality of connecting portions 1242, wherein and the connecting portions 1242 extend from the base 1240 and are connected to the hub 120 and the axial fan blades 122.

The invention can prepare a mold relative to the appearance of the semifinished product 12 of the axial fan wheel in advance and then forges the raw material 10 by the mold, so as to form the semifinished product 12 of the axial fan wheel. Then, step S14 is performed to remove the excess material 124 to form the axial fan wheel 14 with the hub 120 and the axial fan blades 122. In this embodiment, the invention may remove the excess material 124 by a milling process, a punching process or other material removing processes according to practical applications.

Since the hub 120 and the axial fan blades 122 of the axial fan wheel 14 are formed integrally, the invention needs not to assemble the axial fan blades 122 and the hub 120, such that the manufacturing time can be reduced effectively and a connection error will not occur between the axial fan blades 122 and the hub 120. Furthermore, since the axial fan wheel 14 is formed by the forging process, the homogeneity and surface characteristic of the axial fan wheel 14 are good.

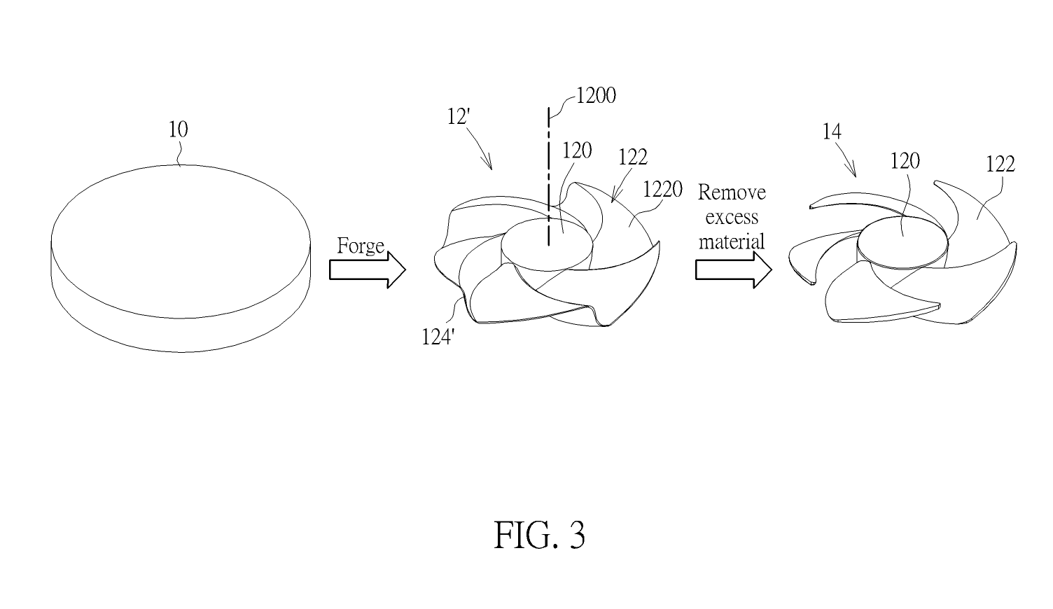

Referring to FIG. 3, FIG. 3 is a schematic view illustrating another process associated with the method shown in FIG. 1. As shown in FIG. 3, the excess material 124′ of the semifinished product 12′ of the axial fan wheel does not have the base 1240 shown in FIG. 2.

In other words, the invention may forge the raw material 10 by different molds, so as to generate the semifinished products 12, 12′ of the axial fan wheel with different excess materials 124, 124′.

As mentioned in the above, the invention forms the semifinished product of the axial fan wheel by the forging process first and then removes the excess material from the semifinished product of the axial fan wheel, so as to obtain the axial fan wheel with the hub and the axial fan blades integrally. Since the invention needs not to assemble the axial fan blades and the hub, the manufacturing time can be reduced effectively and a connection error will not occur between the axial fan blades and the hub.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing an axial fan wheel comprising:
providing a raw material;
forging the raw material by a forging process to form a semifinished product of the axial fan wheel, wherein the semifinished product of the axial fan wheel comprises a hub, a plurality of axial fan blades and an excess material, the axial fan blades extend from a periphery of the hub, an angle included between a surface of each axial fan blade and a rotation axis of the hub varies gradiently, and the excess material is connected to the hub and the axial fan blades; and
removing the excess material to form the axial fan wheel with the hub and the axial fan blades.

2. The method of claim 1, wherein the excess material comprises a base and a plurality of connecting portions, and the connecting portions extend from the base and are connected to the hub and the axial fan blades.

3. The method of claim 1, further comprising:
removing the excess material by a milling process or a punching process.

4. The method of claim 1, wherein the raw material is Mg, Al, Fe, Ti or an alloy thereof.
